(19) United States
(12) Patent Application Publication
(10) Pub. No.: US 2006/0078871 A1
(43) Pub. Date: Apr. 13, 2006

(54) Instructional center

(76) Inventor: Gary L. Turner, Burley, ID (US)

Correspondence Address: STARKWEATHER & ASSOCIATES, 9035 SOUTH 1300 EAST, SUITE 200, SANDY, UT, 84094, US

(21) Appl. No.: 11/227,835

(22) Filed: Sep. 14, 2005

Related U.S. Application Data
(60) Provisional application No. 60/612,101, filed on Sep. 22, 2004.

(51) Int. Cl. G09B 19/00

(52) U.S. Cl. 434/433

(57) ABSTRACT

An instructional center including a first step substantially horizontal to a ground surface; a second step substantially horizontal to the ground surface, located further from the ground surface than the first step and not directly above the first step; a step riser located between the first and second steps, and a storage shelf. The instructional center may include a right section, a left section and a center section located between the left and right sections. The right, left, and center sections of the instructional center may be arranged and fit together such that the instructional center is substantially in a “V,”, “U,” or semicircle. The center section may by substantially hourglass-shaped when viewed from above or below.

### CLAIM OF PRIORITY

This invention claims priority, under 35 U.S.C. § 120, to the U.S. Provisional Patent Application No. 60/612,101 to Gary L. Turner filed on 22 Sep. 2004, which is herein incorporated by reference.

### BACKGROUND OF THE INVENTION

1. Field of the Invention

The present invention relates to instructional centers, specifically instructional centers for use in classrooms to direct student attention to a central location.

2. Description of the Related Art

Schoolteachers use various methods of teaching students. Perhaps one of the greatest challenges for schoolteachers, particularly, those teachers teaching elementary school, kindergarten, and preschool, is effectively teaching all students at the same time. This challenge becomes more and more difficult for large classrooms with high student counts. It has been observed that the proximity of students to the teacher allows early detection of learning and/or behavioral problems.

In large classrooms, with students sitting at desks oriented in rows, columns, circles, tables, groups, etc., it is difficult to effectively teach all of the students at the same time. Due to the size of the desks, and the room required between desks, a number of students are unfortunately pushed into the back of the room. Other students are forced to the side of the room. The most fortunate students are positioned near the front and center of the room where the teacher's voice is clearly understood, where the students can easily see and view teaching lessons on the chalk or grease boards, and where the students are generally more behaved.

Some schools have made use of portable seating systems that allow the students to sit in a generally semi-circular configuration around a central area of focus, generally the teacher. Unfortunately, due to the mobile nature of the portable seating systems, they may only be used for a short period of time, they are heavy, generally compact in size, unstable, very expensive, don't make good use of space, and appear unattractive in relation to the rest of the classroom.

Kniefel, et al. teaches in U.S. Pat. No. 5,357,876 a portable riser unit for supporting persons or objects above the ground, a floor, a stage or the like. The riser broadly comprises a base, generally rectangular step members, and hinge joints for pivotally, hingedly connecting the step members to the base. The base has an integrally formed, convoluted internal or interior support and baffle wall structure and may be filled with an appropriate low density, high volume material. Each step member also may be of this construction; however, the step members may or may not have an internal support wall. The step members are operably coupled to the base by double axis hinges including hinge blocks received in complementary hinge wells in the base and step members. The hinges are self-leveling to present a substantially smooth, level riser support surface in every possible configuration. The riser may be molded of a plastic material and includes integral hand grips to facilitate moving step members or the entire riser. By manipulating the step members, the riser may be re-shaped into a variety of operable configurations. The invention also encompasses connector keys for connecting two or more risers into a riser assembly.

U.S. Pat. No. 3,974,894 discloses a portable riser having a plurality of steps which have a travel position in superimposed relation with structure for rolling the riser along the floor, hinge means interconnecting the steps whereby they may be folded out of superimposed relation, a pair of sliders pivotally associated with each step and which are hinged to sliders of an adjacent step by said hinge means whereby lifting of one step causes erection of the riser to an erected position, and latch means automatically operable to prevent movement of the steps beyond erected position and to lock the riser in erected position for use.

Further, a portable riser is disclosed in U.S. Pat. No. 5,901,505. The choral riser disclosed in this patent is adapted to be supported on a stage surface. The choral riser has a base that presents two spaced apart base supports, each of the base support having a first and a second spaced apart pivot point. A first step member has a step pivot point and a base pivot point that is operably pivotally coupled at the base pivot point to the base at the base first pivot point and has at least one step presented thereon. A second step member has a step pivot point and a link pivot point that is operably pivotally coupled at the step pivot point to the first step member at the first step member step pivot point and has a plurality of steps presented thereon. A bar link member is operably pivotally coupled at a first end pivot point to the second step member bar link pivot point. The bar link member is operably pivotally coupled at a second end pivot point to the base second pivot point. The first and second step members are pivotable between a stowed configuration, with at least one of the steps of the first step member facing at least one of the steps of the second step member, and an operational configuration in which the steps of the first and second step members present an ascending succession of steps. The steps are readily reversible to change the stage presentation form.

What is needed is an instructional center that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available instructional center. Accordingly, the present invention has been developed to provide an instructional center which may include a first step substantially horizontal to a ground surface; a second step substantially horizontal to the ground surface, located further from the ground surface than the first step and not directly above the first step; a step riser located between the first and second steps, and a storage shelf. The instructional center may include a right section, a left section, and a center section located between the left and right sections, and in contact with the left and right sections.

In one embodiment, an intersection between the first step and the step riser of the right section is not collinear with an intersection between the first step and step riser of the left section or with an intersection between the first step and step riser of the center section.

An intersection between a line parallel with an intersection between the first step and the step riser of the right section may be parallel with an intersection between the first step and the step riser of the left section. The intersection between the first step and the step riser of the right section may be about 45° with an intersection between the first step and the step riser of the center section. The intersection between the first step and the step riser of the left section may be about 45° with an intersection between the first step and the step riser of the center section. The intersection may include a ground riser.

In one embodiment, the instructional center includes a cavity. The instructional center may include an enclosure panel. The instructional center may include access to the cavity through the enclosure panel. The enclosure panel may be a hinged door, a sliding door, a folding door, and/or a drawer. The cavity may include the storage shelf. The storage shelf may be a retractable storage shelf. The retractable storage shelf may include rollers mounted on the retractable storage shelf, and communicable with runners mounted inside the cavity. Each of the left, right, and/or center sections may include a cavity with a storage shelf. The cavity may have boundaries which include a second step located above the first step, two end panels, the step riser, and/or a ground surface.

In one embodiment the instructional center includes a covering.

In an embodiment where the instructional center includes a left, right and center section, the center section may be in a shape such that when it is coupled with the right and left sections, intersections between the step risers and the first steps of the left and right sections form an angle of about 45° with an intersection between the step riser and the first step of the center section comprise angles of about 45°. The center section may include female corners couplable with the left section and the right section.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates a perspective view of an instructional center according to one embodiment of the present invention;

FIG. 2 illustrates an exploded perspective view of an instructional center according to one embodiment of the present invention;

FIG. 3 illustrates a bottom plan view of a center section of an instructional center according to one embodiment of the present invention; and

FIG. 4 illustrates a plan view of a storage shelf of an instructional center according to one embodiment of the present invention.

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment.” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment, different embodiments, or component parts of the same or different illustrated invention. Additionally, reference to the wording “an embodiment,” or the like, for two or more features, elements, etc. does not mean that the features are related, dissimilar, the same, etc. The use of the term “an embodiment,” or similar wording, is merely a convenient phrase to indicate optional features, which may or may not be part of the invention as claimed.

Each statement of an embodiment is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The independent embodiments are considered to be able to be combined in whole or in part one with another as the claims and/or art may direct, either directly or indirectly, implicitly or explicitly.

Finally, the fact that the wording “an embodiment,” or the like, does not appear at the beginning of every sentence in the specification, such as is the practice of some practitioners, is merely a convenience for the reader's clarity. However, it is the intention of this application to incorporate by reference the phrasing “an embodiment,” and the like, at the beginning of every sentence herein where logically possible and appropriate.

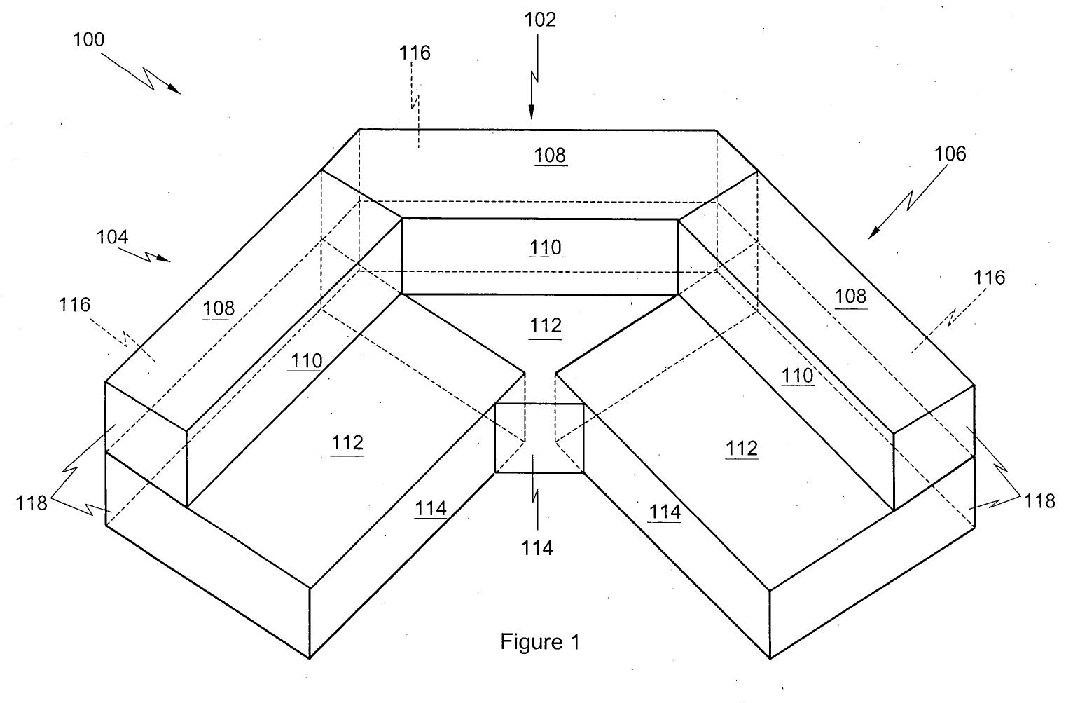

The instructional center of the present invention includes at least one riser, at least two steps, and at least one storage shelf. FIG. 1 illustrates a perspective view of an instructional center according to one embodiment of the present invention. In this embodiment, the instructional center 100 includes a step riser 110, a first step 112, a second step 108, and a storage shelf 116. The instructional center 100 of this embodiment includes three sections, a left section 104, a right section 106, and a center section 102. The instructional center 100 of this embodiment also includes a ground riser 114.

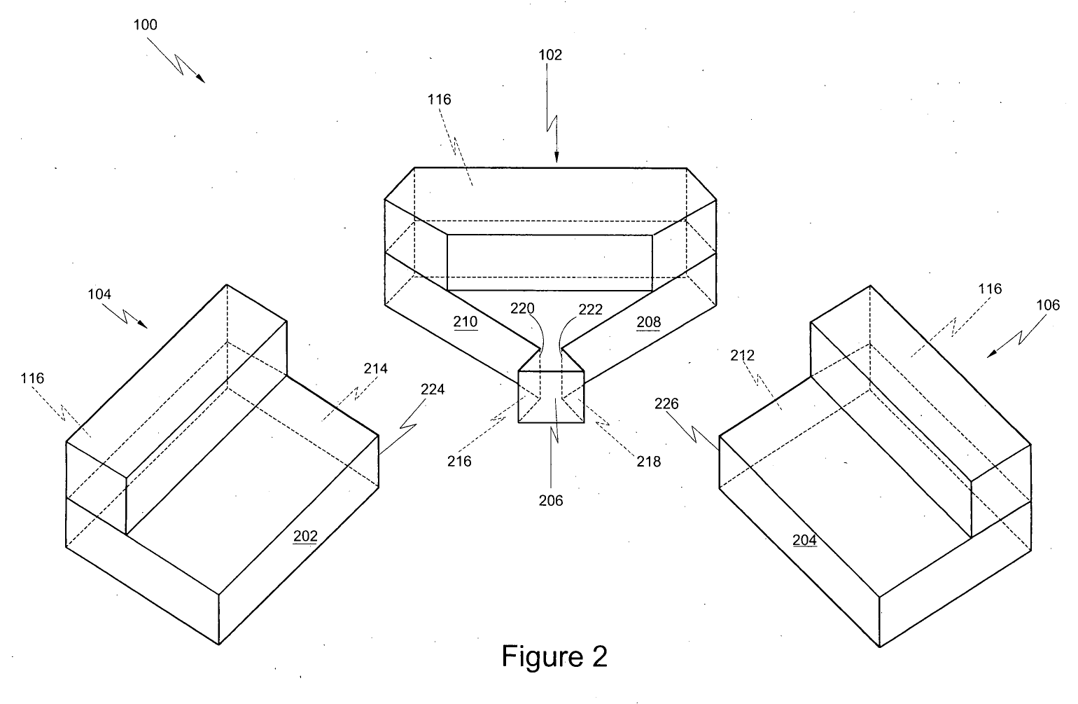

The left section 104, right section 106, and center section 102 of this embodiment fit together. FIG. 2 illustrates an exploded view of an instructional center according to one embodiment of this invention. In this embodiment, the right section 106 includes a surface 212 configured to contact a surface 208 of the center section 102. The left section 104 includes a surface 214 configured to contact a surface 210 of the center section 102. The center section 102 includes a surface 216 configured to contact the ground riser 202 of the left section, and a surface 218 configured to contact the ground riser 204 of the right section 106. The center section also includes a female corner 220 configured to contact with the male corner 224 of the left section 104, and a female corner 222 configured to contact with the male corner 226 of the right section 106. The center section 102 also includes a ground riser 206. Each of the left 104, center 102, and right 106 sections also include a shelf 116.

The embodiments of the present invention illustrated in FIGS. 1 and 2 show an instructional center 100 whereby the left 104 and right 106 sections are substantially orthogonal when placed together. That is, a line parallel with the intersection of the first step 112 and the step riser 110 of the left section 104 is substantially orthogonal with a line parallel with the intersection of the first step 112 and the step riser 110 of the right section 106. Further, in these embodiments, the left 104 and right 106 sections each make angles of about 45° with the center section 102. That is, lines that are parallel with the intersection of the first steps 112 and the step risers 110 or the left 104 and right 106 sections make about a 45° angle with a line that is parallel with the first step 112 and the step riser 110 of the center section 102.

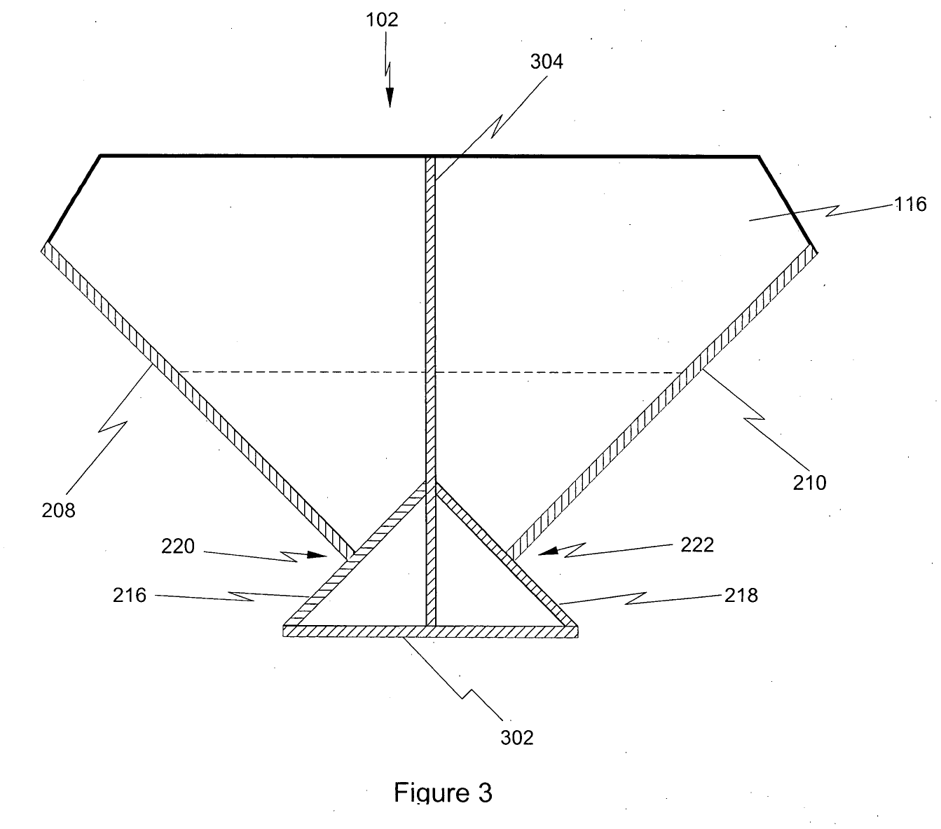

FIG. 3 illustrates a bottom plan view of the center section 102 of one embodiment of the instructional center 100 (see FIG. 1). Viewed from the bottom or top, the center section 102 of this embodiment is substantially hourglass shaped. That is, the center section 102 includes two female corners 220 and 222. The female corners 220 and 222 are configured to fit with male corners 224 and 226 of the left 104 and right 106 sections. In this embodiment, the female corner 220 configured to fit the left section 104 (see FIG. 1) is a corner between contacting surfaces 210 and 216 configured to contact the left section 104 (see FIG. 1). The female corner 222 configured to fit the right section 106 is a corner between contacting surfaces 208 and 218 configured to fit the right section 106 (see FIG. 1). A contacting surface 216 of the center section 102 is configured to contact the ground riser 202 of the left section 104 (see FIG. 1). A contacting surface 218 is configured to contact the ground riser 204 of the right section 106 (see FIG. 1). When the right, 106 (see FIG. 1) left, 104 (see FIG. 1) and center 102 sections are fit together, each of the right, 106 (see FIG. 1) left, 104 (see FIG. 1) and center 102 sections may be used as sitting locations.

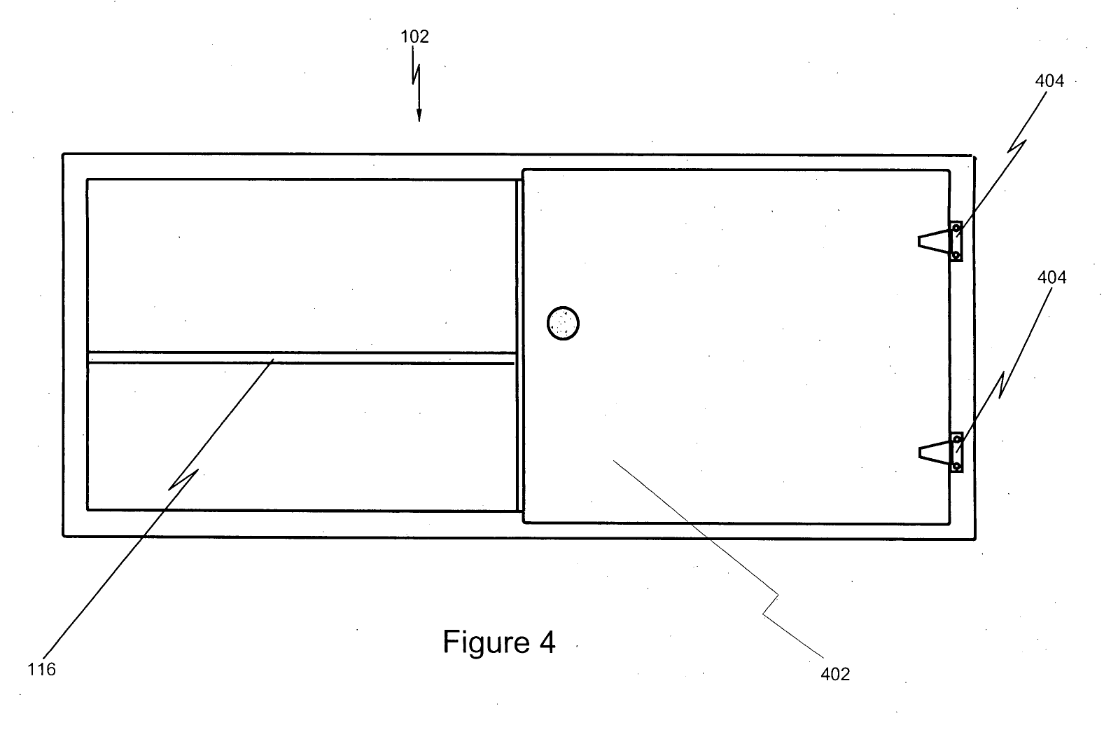

As can be seen in the embodiment illustrated in FIG. 1, the instructional center 100 of this invention may also include a shelf 116. The shelf 116 may be located anywhere on the instructional center 100. Preferably, the shelf 116 is not located on either the first step 108 or the second step 112. In another embodiment, as illustrated in FIGS. 1-3, the shelf 116 is located in a cavity. In this embodiment, the shelf 116 may be coplanar with the second step 112. In one embodiment, the cavity is defined by boundaries which include the second step 108, the step riser 110, and a ground surface. The cavity may be further defined by boundaries which may include one or more of the following: a ground riser 114, a first step 112, an enclosure panel 402 (see FIG. 4), dividers 304, side panels 118, and so forth. The shelf 116 may be designed to store or display items. In one example, the instructional center 100 may be used in a schoolroom, and schoolroom items may be stored or displayed on the shelf 116. In another example, the instructional center 100 may be used in a library, and library items such as books may be stored or displayed on the shelf 116.

An enclosure panel 402 may be used to define the cavity. Any enclosure panel known in the art may be used. An enclosure panel may be used to allow access to the cavity. Thus, in an embodiment where the shelf 116 is located in the cavity, the enclosure panel may allow access to the shelf 116. FIG. 4 illustrates a shelf 116 inside of a cavity of a center section 102 and an enclosure panel 402 according to one embodiment of the invention. In this embodiment, the enclosure panel 402 is in the configuration of a door with hinges 404. The enclosure panel 402 may be opened to allow access to the contents of the cavity.

A ground surface may be any surface defining the bottom of the instructional center 100. For example, the ground surface may be the flooring or ground upon which the instructional center 100 sits. In another example, the ground surface is a part of the instructional center 100. In an embodiment where there is no ground riser 114, the ground surface may be located on the same plane as the first step 112.

In one embodiment, the shelf 116 is designed to be removed from within the cavity with the items displayed or stored on the shelf 116. For example, the shelf 116 may include rollers, and the cavity may include runners upon which the rollers are configured to roll. In this example, the shelf 116 may be maintained substantially horizontal as it is removed from within the cavity and returned back to within the cavity. In another example, the shelf 116 may include a runner-contacting surface, and the cavity may include runners configured to contact the runner-contacting surface. In this example, the shelf 116 may slide on the runners to be removed from within the cavity, and returned to the cavity. In one example, the shelf 116 is not completely removed from within the cavity. In this example, the shelf 116 may maintain contact with runners in the cavity.

In yet another embodiment, the instructional center may be covered. Any covering known in the art may be used to cover the instructional center. In one embodiment, a textile covers the instructional center. The textile may include, materials from the following list: woven cloth such as carpeting, satin, cotton material, wool material, and so forth; non-woven cloth such as felt, pressed fibers, and so forth; extruded textiles such as imitation leather, linoleum, and so forth; plastics; wood paneling; upholstery; cushioning; and so forth.

In one embodiment, carpeting covers the instructional center. The seams of the carpet covering may be considered to be unsightly. Thus the instructional center may be designed to substantially hide or obscure these seams. In this embodiment, the risers, 110 114 steps, 112 108 and side panels 118 are configured to slightly overlap such that the seams in the carpet covering are not exposed.

The instructional center may be constructed to support the weight of one or more people. One of the uses of the instructional center is as a sitting or standing surface for students. In one embodiment, the instructional center is used in a classroom. Students may sit or stand on a step of the instructional center. As they sit or stand on the instructional center, their attention may be drawn to a common focal point. The teacher or instructor may choose to teach or instruct from that common focal point. In this embodiment, the storage shelf may be used to store classroom or student supplies.

In another embodiment, the instructional center is used in a library. Library patrons, students, or others may sit or stand on a step of the instructional center. The attention of those sitting or standing on the instructional center may be directed toward a common focal point, where there may be a teacher, lecturer, or other such activity. Alternatively, those sitting or standing on the instructional center may be involved in other activities such as reading, studying, playing games, and so forth. In this embodiment, the shelf may be used to store or display items typically found in a library such as books, CD's DVD's, artwork, puzzles, games, educational material, announcements, fliers, and so forth.

It is understood that the above-described preferred embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claim rather than by the foregoing description. All changes which come within the meaning and range of equivalency of the claims are to be embraced within their scope.

For example, although the specification names various angles for the intersections between the various sections, it is envisioned that many suitable angles may be used. If the instructional center is to be used, for example, in a classroom setting, it may be desirable to form the instructional center in a manner that would direct the attention of the students sitting on the instructional center toward a teacher. Thus, any angles between the sections that would create a generally V-, U-, or semicircular-shaped instructional center would be within the scope of this invention. In one embodiment, the angle between the left section and the right section is at least about 10°, or at least about 25°; and less than about 180°, or less than about 150°.

Though in one embodiment in the specification, the angle between the left section and the center section is identical to the angle between the right section and the center section, it is also within the scope of this invention that those angles are not identical. In one embodiment the angle between the left and right sections is 60°. In this embodiment, the angle between the right section and the center section, and the angle between the left section and the center section could be equal, that is, each could be 30°. In this embodiment, the angle between the right section and the center section, and the angle between the left section and the center section may be unequal, that is one could be, for example, 40°, and the other could be 20°. Alternatively, one angle could be 10° while the other is 50°.

Additionally, although the figures illustrate that the angle between the step riser and the first step is approximately orthogonal, this angle may be chosen for the intended use of the instructional center. For example, if the instructional center is designed for students to sit on with their backs contacting the step riser and their legs contacting the first step, the angle between the step riser and the first step may be selected to accommodate a sitting student. In one embodiment, the angle between the step riser and the first step is at least about 90°, or at least about 80°; and less than about 180°, or less than about 120°.

Further, though the figures illustrate that the first step is approximately horizontal, the angle between this surface and the ground may vary. In one example the first step tilts such that it is lowest along the line where it contacts the step riser. This example may be helpful to keep children in their seats. In another example the first step tilts such that it is highest along the line where it contacts the step riser.

It is also envisioned that the enclosure panel may be produced from any material known in the art. The enclosure panel may be designed in accordance with the desired properties. For example, if more security is desired for the intended contents of the cavity, the enclosure panel may be produced from a sturdy material, and may be able to be locked. In this example, the enclosure panel may be produced from wood, metal, metal alloy, composite material, plastic, glass, and the like. Further, the enclosure panel may be lockable. For example, the enclosure panel may be in the form of a door with a latch and loop. The latch is placed over the loop, and a lock may be placed through the loop to effectively lock the enclosure panel closed.

In another example, it may be desirable to allow for the contents of the cavity to be viewed even though the enclosure panel is closed. In this example, the enclosure panel may be produced from a material that allows light to be transmitted through the material. In another example only a part of the enclosure panel is produced from a material that allows the passage of light. A transparent enclosure panel may be desirable where the enclosure panels are able to slide. In this configuration, at least two enclosure panels are able to slide with each other, that is, to access a portion of the cavity, one enclosure panel may be slid to overlap another panel. If the enclosure panels are transparent, the entire contents of the cavity could remain in view though the enclosure panels continue to cover at least a portion of the cavity.

As to the shelf, several shelf configurations may be used. In one embodiment, the shelf is not located inside the cavity. One example of this embodiment is a shelf that is attached to a side panel. The shelf of this example may be foldable such that when not in use it may fold to be substantially coplanar with the side panel. In another example, the shelf is attached to the enclosure panel. In this embodiment, the enclosure panel may be immoveable to grant access to a cavity resulting in a shelf protruding outwardly from the enclosure panel. Also in this embodiment, the shelf may be attached to the inside of the enclosure panel such that the shelf is exposed when the enclosure panel is opened. For example, the enclosure panel may be a swinging door with the shelf attached to the surface of the enclosure panel facing the cavity when the enclosure panel is closed. In this example, access to the shelf is available when the enclosure panel is opened. Optionally the shelf may be on an additional structure on a step or attached to a riser. Such a shelf may be desirable for a person sitting on the first step in that when sitting on the first step the shelf may be more accessible to the person.

Finally, it is envisioned that the components of the instructional center may be constructed of a variety of materials. The risers, steps, dividers, and panels may be made of any material known in the art suitable for the purposes of the instructional center. For example, the instructional center may be formed of wood, plywood, metal, polymer, composite material, glass, and so forth.

The instructional center need not include a cavity. In one example, the instructional center is solid. A solid instructional center may be formed from a foam such that it is not unduly weighty, or may be moved more easily than a heavy instructional center. The instructional center may be formed from a relatively dense material such as stone or concrete. An instructional center of this type is more permanent than a hollow or foam instructional center.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

In order to demonstrate the practice of the present invention, the following examples have been prepared. The examples should not, however, be viewed as limiting the scope of the invention. The claims will serve to define the invention.

### EXAMPLE

In one example, the instructional center is located in a classroom as a kiva or group instructional setting. The classroom is a traditional classroom with an instructional center adapted into the classroom. The classroom includes both the instructional center and traditional desks. The instructional center may be used for group instruction. Students can return to a desk if asked to, for example, for behavioral problems, and yet still remain under the supervision of the teacher while attending to those students still on the risers. Students learn quickly that this is the place to be during such instructional times. The student who must ask to come back may be placed in a situation where he or she must make certain commitments that effect behavioral change in a hurry. Teachers may become better organized and focused for shorter bursts of time. When students return to the traditional work area, they work separately or together on practice and implementation skills. The teacher may play a monitoring role and preserves the integrity of the kiva system which establishes a zone of high expectation and low anxiety. Teachers who use the device of this example say they would not teach without it.

In another example, the instructional center is constructed in a modular fashion. That is, the left, right, and center sections are constructed as separate pieces that may be placed together when in the classroom. This has the advantage that the instructional center may be placed into a classroom without the previous expensive and intrusive techniques of building concrete pit-type kivas. The modular design may be constructed in the shape and size to fit the classroom into which the instructional center is to be placed.

What is claimed is:

1. An instructional center, comprising:
a first step substantially horizontal to a ground surface;
a second step substantially horizontal to the ground surface, located further from the ground surface than the first step and not directly above the first step;
a step riser located between the first and second steps; and
a storage shelf.

2. The instructional center of claim 1, further comprising a left section, a right section, and a center section located between the left and right sections, and in contact with the left and right sections.

3. The instructional center of claim 2, wherein:
an intersection between the first step and step riser of the right section is not collinear with an intersection between the first step and step riser of the left section or with an intersection between the first step and step riser of the center section.

4. The instructional center of claim 2, further comprising a substantially orthogonal intersection between a line parallel with an intersection between the first step and the step riser of the right section and a line parallel with an intersection between the first step and the step riser of the left section.

5. The instructional center of claim 4, further comprising:
an angle of about 45° between the intersection between the first step and the step riser of the right section and an intersection between the first step and the step riser of the center section; and
an angle of about 45° between the intersection between the first step and the step riser of the left section and an intersection between the first step and the step riser of the center section.

6. The instructional center of claim 1, wherein the instructional center includes a cavity.

7. The instructional center of claim 6, further comprising an enclosure panel.

8. The instructional center of claim 6, further comprising an access to the cavity using the enclosure panel.

9. The instructional center of claim 6, wherein the cavity includes the storage shelf.

10. The instructional center of claim 6, wherein each of the left, right, and center sections further comprise a cavity and a storage shelf.

11. The instructional center of claim 6, wherein the cavity includes boundaries comprising:
the second step;
two end panels;
the step riser; and
a ground surface.

12. The instructional center of claim 7, wherein the enclosure panel comprises one selected from the list consisting of: a hinged door, a sliding door, a folding door, and a drawer.

13. The instructional center of claim 9, wherein the storage shelf comprises a retractable storage shelf.

14. The instructional center of claim 13, wherein the retractable storage shelf includes rollers mounted on the retractable storage shelf, and communicable with runners mounted inside the cavity.

15. The instructional center of claim 1, wherein the instructional center includes a ground riser located below the first step.

16. The instructional center of claim 2, wherein the center section comprises a shape such that when coupled with the right and left sections, intersections between the step risers and the first steps of the left and right sections and an intersection between the step riser and the first step of the center section comprise angles of about 45°.

17. The instructional center of claim 2, wherein the center section comprises an hourglass-shaped second step.

18. The instructional center of claim 17, wherein the center section comprises two surfaces that contact the left section and two surfaces that contact the right section.

19. The instructional center of claim 2, wherein the center section comprises female corners couplable with the left section and the right section.

20. An instructional center, comprising:
a left section which includes:
a first step substantially horizontal to a ground surface;
a second step substantially horizontal to the ground surface, located further from the ground surface than the first step and not directly above the first step;
a step riser located between the first and second steps; and
a shelf internal to the instructional center;
a right section which includes:
a first step substantially horizontal to a ground surface;
a second step substantially horizontal to the ground surface, located further from the ground surface than the first step and not directly above the first step;
a step riser located between the first and second steps; and
a shelf internal to the instructional center; and
a center section, located between the left and right sections which includes:
a first step substantially horizontal to a ground surface;
a second step substantially horizontal to the ground surface, located further from the ground surface than the first step and not directly above the first step;
a step riser located between the first and second steps; and
a shelf internal to the instructional center.
